(19) United States
(12) Patent Application Publication
(10) Pub. No.: US 2003/0061150 A1
(43) Pub. Date: Mar. 27, 2003

(54) Electronic transaction system

(76) Inventor: Robert William Kocher, Arlington, VA (US)

Correspondence Address: ROBERT W. KOCHER, 4828 3RD ST. N., ARLINGTON, VA, 22203, US

(21) Appl. No.: 10/274,486

(22) Filed: Oct. 21, 2002

Related U.S. Application Data
(62) Division of application No. 09/426,712, filed on Oct. 26, 1999.

(51) Int. Cl. G06F 17/60

(52) U.S. Cl. 705/37; 705/26

(57) ABSTRACT

The system and method for electronic value determination and pawn brokering will enable new methods and efficiencies for pawning through electronic commerce. This invention includes: on-line value determination; options for pawning, selling or buying an item; electronic and manual appraisals; pawn brokering; and collateralized lending, buying, and reselling services. Alternate embodiments include an artificial intelligence system that assesses items' values by monitoring similar items being bought and sold thought out the world. The system can factor in business costs and profit margins to computes each item's value. The system electronically interfaces with potential pawning and selling customers and makes tentative offers to buy or lend money for a fully collateralized loan. The result is better price spreads between pawn prices and resale prices. Added features may include a collateralized credit card that requires neither monthly payments nor paying off the balance when ‘maxed out’. Customers get better value for items pawned or sold and better lending rates when compared to traditional pawn brokering. With this invention, pawning could emerge as a safer, less risky way to borrow—far superior unsecured credit card loans, which are responsible for the significant rise in defaults and bankruptcy.

### CROSS REFERENCE TO RELATED APPLICATIONS

Not Applicable

### STATEMENT REGUARDING FEDERALLY SPONSORED RESEARCH OR DEVELOPMENT

Not Applicable

### REFERENCE TO A MICROFICHE APPENDIX

Not Applicable

### FIELD OF INVENTION

The present invention relates to a system and method that enables Internet users to pawn, buy, and sell goods over electronic commerce applications using digital and analog networks. More particularly, the present invention provides transactional capabilities for pawning, buying and selling, enhanced with access to value determination through interaction with a plurality of open market sites, buyers, sellers, through a web site.

### BACKGROUND OF THE INVENTION

The advent of electronic commerce has revolutionized the ways we do business by creating new business methods and processes. Inventors have developed numerous patented methods for auctioning, reverse auctioning, loan making, buying and selling over the internet. Until now, however, no one has revolutionized the pawn brokering industry. Electronic value determination and pawn brokering can provide a significant service in electronic commerce markets as an alternate method for collateralized borrowing money, selling of a thing or buying discounted products.

Pawn brokering is one of mankind's oldest financial institutions. Historians can trace pawn brokering back at least 3,000 years to ancient China; and the earliest written histories of Greek and Roman civilizations make reference to it.

Pawnbrokers, also known as collateral loan brokers, make loans based purely on the intrinsic value of the collateral. The customer's past credit history is not important because the broker only considers the value of the thing being pawned. If the customer cannot pay off the loan, or at least the interest during the specified term, the customer forfeits the thing and the broker is free to sell it.

Pawn brokering is growing in today's society:

Pawnshops make over 35 million loans a year.

Approximately 14,000 pawnshops operate throughout the United States today—more than one pawnshop for every two banks.

Owners redeem between 70% and 80% of all things pawned.

As many as 10 percent of the adult population are served by pawnshops each year.

Pawnshops serve as a source of credit to millions of Americans, providing average small-secured loans for a brief time period (two to four months).

Pawnshops offer high quality merchandise for about half the price compared with retail stores.

Currently, most customers and pawnshops conduct business face-to-face in a pawnshop. The transaction begins when a potential borrower enters a pawnshop with the thing he or she wants to pledge. The pawnbroker then assesses the thing's value. The pawnbroker then determines how much to loan the patron for the thing. To insure a profit, brokers normally loan one-third to one-half of the price they can expect to sell the thing for during the worst of times. This relatively low thing valuation is also a typical characteristic of today's pawn brokering.

All customers provide collateral, eliminating the need to distinguish high risk from low risk borrowers. Most loans average between $70 and $100, but can be as high as several thousand dollars, depending on the collateral's value. Contracts vary from state to state; but the average loan period is 90 days. Pawn lending rates are relatively high when compared to credit cards. Interest rates also vary with the amount of the loan, but typically run at 5% per month.

There are numerous problems with today's methods for conducting pawn brokering:

Value Determination. Pawnbrokers vary in how well they can appraise each thing's true value. Nonetheless, both inexperienced and experienced brokers can undervalue things, either to minimize their shop's risks or to make a greater profit. When this happens, pawnshops get a bad reputation and customers get a bad deal.

Competition. To get the best loan interest rates and best prices for their pawned things, sellers/borrowers need to “shop” various pawnshops. Pawnshops have significant flexibility in setting the value of a thing and related interest rates; some have the reputation for “gouging” customers. Currently, shopping the competition by visiting numerous pawnshops is very time consuming because each pawnbroker will want to examine the thing. Inexperienced customers, who lack the knowledge or time, tend not to comparison shop and as a result, pursue other risky paths or sell directly on the open market.

Limited exposure. When a particular region is hit with economic hard times, pawn business lending goes up, while the sale of pawned things goes down. To hedge against losses pawnbrokers allow less money for pawned things. Broad regional markets and exposure is lacking for pawned things originating out of economically depressed areas.

Privacy. Many people do not like to go into pawn stores because “someone might see them and draw the wrong conclusion”. This tends to keep potential customers away who could use the pawn service. Similarly, it keeps potential buying customers away from possible bargains. The result is fewer sales for the pawn stores and fewer opportunities for customers.

Zoning/Location. Since pawnshops generally have a “bad” reputation, zoning permits are difficult to acquire in respected commercial areas. As a result, pawnshops often locate in less desirable locations that are not easily accessible.

Taking out the “Hard Sales” factors. Currently most pawn transactions take place face-to-face, which can put the customers at a disadvantage. The experienced pawnbroker may sense how desperately the customer needs money and under prices the pawned thing. Many potential customers want to avoid such face-to-face haggling.

Capitalization. Quite often, local pawn stores can't afford loans or purchases for high-dollar things, such as jewelry or art. Such things require the pawnbroker to have significant amounts of capital on hand, with limited chances for resale in their pawnshop.

Such issues give pawnshops and pawn brokering a bad reputation, and that reduces the number of potential customers. At the same time, the need for short-term cash still exists for many individuals who resort to unsecured loans or credit cards for fast cash. These practices are a leading cause in the rise in personal bankruptcy.

Other electronic options do exist for raising capital, including Internet selling or auctioning. However, these methods involve permanently selling the thing with little chance of getting it back. In addition, with auctioning, the seller could receive far less than the thing is actually worth. By pawning a thing the borrower/seller receives an agreed-on amount for the thing and can get the thing back by paying off the loan on time.

### SUMMARY

This invention, the system and method for electronic value determination and pawn brokering, enables quick, easy and confidential on-line price quotes, options for pawning, selling, or buying at competitive valuation rates, interests rates, and prices. The system uses a team of appraisers with significant oversight in open market transactions to determine the value of things. Alternatively, in the second embodiment, an artificial intelligent expert valuation system that continually learns and updates the value of things. It does this by monitoring a vast information system of things being sold thought out the world. It factors in business costs and computes a pawned thing's value while electronically interfacing with customers interested in pawning and selling. The result is better price spreads between pawned and resale prices—and that means better value for customers. In addition, customers would receive lower lending rates, more comparable to credit card rates. The result can be a reemergence of pawning as a safer form of borrowing that can reduce reliance on credit cards and, possibility, bankruptcy.

The system and method for electronic value determination and pawn brokering can significantly improve pawn brokering as a convenient means of buying, selling and borrowing by:

Expanding Regional Exposure. Various parts of a country experience economic expansion and recession at any given time. This invention would survey markets around the world to determine a pawned thing's resale value, resulting in a better pawn or selling price for individuals in economically depressed areas. Pawning occurs more frequently in depressed areas; buying is more frequent in areas of relative prosperity.

Artificial Intelligent “Expert System” Appraisal. An artificial intelligent expert valuation system is defined as electronic monitoring of things sold in open markets, using a computerized appraising process. Such a process can determine a thing's value and calculate the price a broker should offer for the thing in order to make a profit. This expert system will take much of the guesswork out of appraisals, resulting in more accurate and current values. Potential customers can access the system electronically and receive a better price. Moreover, customers face minimal risk because they are under no obligation or pressure to proceed with the pawning process.

Discreet Pawning. Customers will conduct their transactions over the Internet and by mail, eliminating the need to visit a pawnshop.

Electronic Descriptions. Electronic text and picture descriptions of pawned things for sale appear on Internet. This allows a wide range of potential buyers to closely examine things for sale without have to find or go to a pawnshop.

High-dollar Things. This invention has a worldwide reach into open markets and access to a broad spectrum of appraisers. Therefore, high-dollar things such as jewelry and art, can be considered for larger loans. Smaller pawn store chains aren't able to do that because their capital and appraisal abilities are limited.

Fewer Bankruptcies. Pawning avoids the possibility of defaulting on a loan. The loan can be considered paid-in-full at the time it is issued because the broker holds the pawned thing as full collateral. This could result in a decrease in bankruptcy that comes from overextending on credit cards. In addition, this system could benefit the elderly, who tend to have a significant number of pawnable things and little cash. They wouldn't have to worry about defaulting on unsecured loans.

Simple to use credit. A credit card can be issued to charge against the value of the thing. The option of not making monthly payments can be made and the monthly payments can be charged directly from the collateralized thing's value. Statement can read how much the appraised price for the pawned thing, how much money was borrowed against the pawned thing, how much was charged on the credit card, storage charges, interest charges, and how much is left. The minimum payment on every monthly statement is zero. Once the credit card is “maxed-out” the user has the option to make a payment to forfeit the collateralized thing to the broker.

Expert appraisal. Certain high-dollar things require expert appraisal once the thing is received. This appraisal can appear with the electronic selling description, with a copy going to the buyer.

Collectibles. Collectibles, such as coins, stamps, trains, and sports memorabilia, are natural areas for electronic value determination and pawn brokering. Collectible things have very good classes, grading and descriptions, and have relatively stable resale values. Pawning allows customers to receive a short-term loan for their collections, which may be very valuable, without having to sell them.

Warrantees. Since each received thing goes through a detailed inspection, selected things can be sold with warrantees or guarantees.

### DRAWING FIGURES

FIG. 1 shows a general overview of the major system components according to the present invention for enabling pawning, selling, and buying, warehousing, reselling and interaction with secondary markets.

FIG. 2 shows the first embodiment with additional details for customer interface and the web site process.

FIG. 3 shows the first embodiment for value determination of things for pawning and selling.

FIG. 4 shows the second embodiment of the invention using an artificial intelligent expert valuation system to monitor open market sales and determine the best “pawn” value for a thing.

FIG. 5 shows the warehouse and its activities.

FIG. 6 shows the reselling process and its activities with secondary markets.

### LIST OF REFERENCE NUMERALS

Item 1 is a plurality of customers with thing(s) to pawn, sell or buy over the communications network.

Item 1.P is a plurality of pawning customers.

Item 1.S is a plurality of selling customers.

Item 1.B is a plurality of buying customers.

Item 2 is the communications network for customers.

Item 3 is customers' goal path i.e. buy, sell, or pawn.

Item 4 is the pawn path.

Item 5 is the sell path.

Item 6 is the buy path.

Item 7 is the buy-sell-pawn web site.

Item 8 is the value determination module for determining the price to offer for a thing.

Item 9 is the reselling site.

Item 10 is the internet direct selling connection with the reselling site.

Item 11 is the reselling connection with secondary markets.

Item 12 is the feedback loop into the value determination model to update sales prices.

Item 13 is the pawn-loan-processing site.

Item 14 is the pawn-processing site's communications link with the warehouse.

Item 15 is the selling processing site.

Item 16 is the selling processing site's communications link with the warehouse.

Item 17 is the shipping path between customers and the warehouse.

Item 18 is the communications link to monitor secondary markets transactions.

Item 19 is the communications network for open markets.

Item 20 represents open markets.

Item 21 represents electronic selling sites.

Item 22 represents electronic auction and reverse auction sites.

Item 23 represents traditional selling sites.

Item 24 represents traditional auction sites.

Item 25 represents traditional appraisal information sites.

Item 26 is the communications link between web site management and the warehouse.

Item 27 is the warehouse.

Item 28 is the shipping path to secondary markets for things sold.

Item 29 is the communications link between the expert system to the secondary markets.

Item 30 is the expert system based on artificial intelligence.

Item 31 is the communications link between the expert system and value determination site.

Item 32 is the receiving department.

Item 33 is the path for things requiring only a simple inspection verification.

Item 34 is the path for things requiring human appraiser for verification.

Item 35 is the human appraiser.

Item 36 is the human inspector.

Item 37 is the path for things post inspection to storage (if pawned) or maintenance (if sold).

Item 38 is the path for post appraisal things to storage (if pawned) or maintenance (if sold).

Item 39 is the storage site for things pawned or awaiting to be sold.

Item 40 is the maintenance/repair site.

Item 41 is the path for things after maintenance/repair.

Item 42 is the documentation site.

Item 43 is the path to storage, awaiting sale.

Item 44 is the path for things sold or pawned things to be sent to shipping.

Item 45 is the shipping site, which ships sold things to buyers and pawned things that have, been paid off back to the original owners.

Item 46 is the shipping path to buyers in the secondary market.

Item 47 is the shipping path to buyers from the pawn web site.

Item 48 is the shipping path to original pawning customers who have paid off their pawn loans.

Item 49 is the selling processing site's communications link with the reselling site.

### DETAILED DESCRIPTION OF THE INVENTION

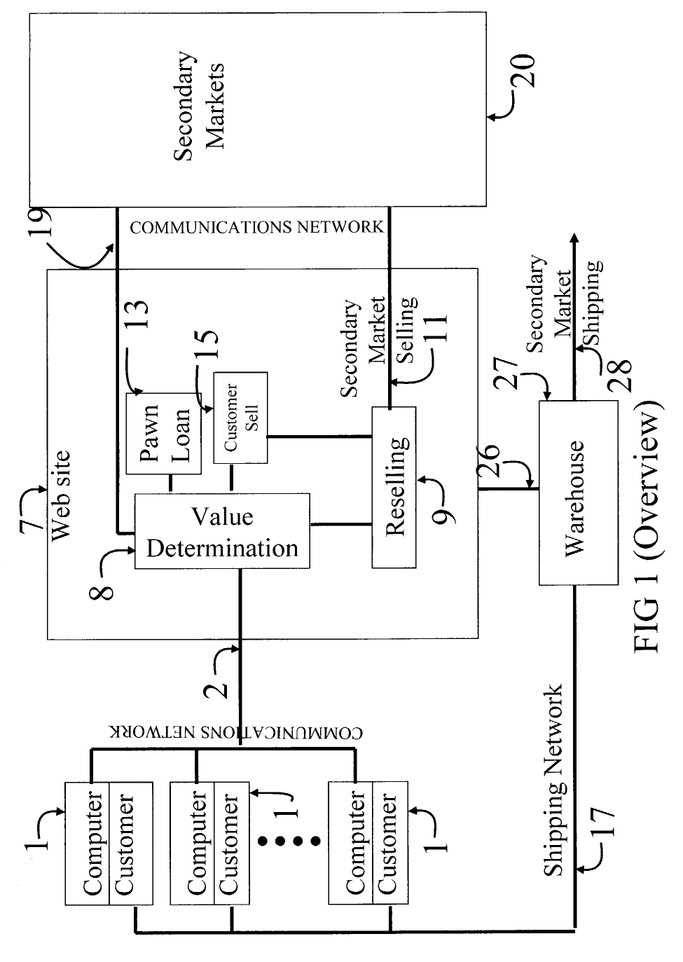

FIG. 1 depicts an overview of the key elements of the main embodiment. The key elements of the main embodiment are customers 1 with electronic interfaces, such as a computer, that communicate through a communications network 2 with the buy-sell-pawn website 7. The web site 7 contains a value determination system 8 that monitors and communicates directly with secondary markets 20 through a communications network 19. The web site 7 also contains a reselling site 9 that communicates 19 with the secondary markets 20 to offer things for sale. A pawn-loan site 13 processes pawning instructions and loans for customers 1 with things to pawn. A sell-processing site 15 processes instructions and payment for customers 1 with things to sell. The warehouse 27 receives things from selling and pawning customers 1 over a shipping systems, 17 such as a freight service or the postal service. The warehouse 27 receives its instructions and communications from the pawn loan site, sell site, and reselling site through various communications links 26. When instructed, the warehouse 27 ships 28 to buyers in the secondary market 20.

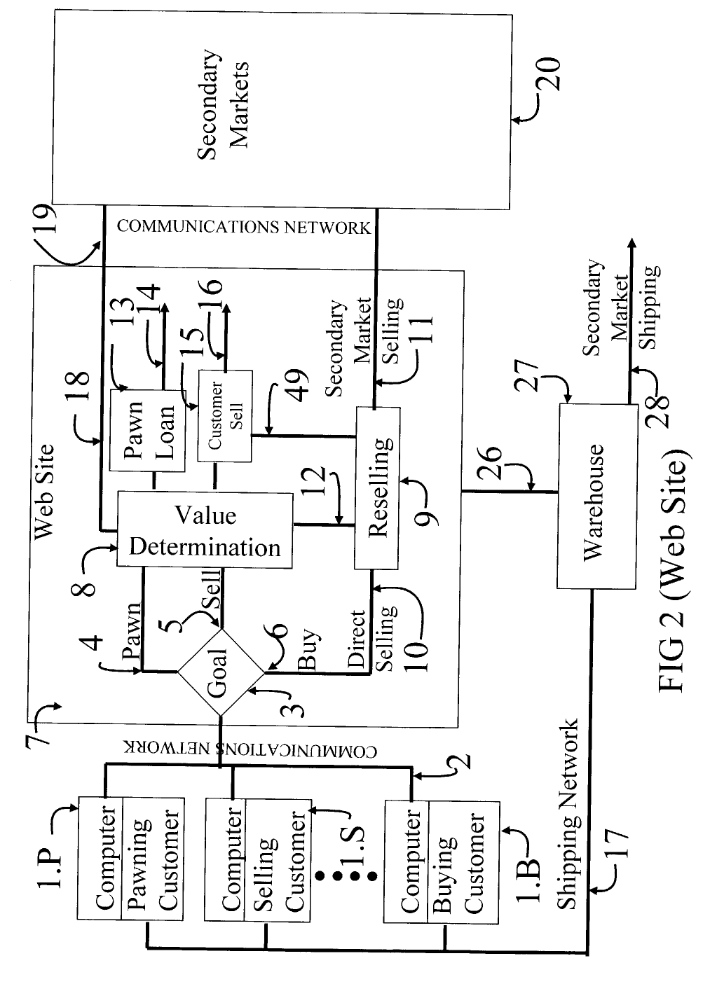

FIG. 2 depicts more detail functioning of the internal web site 7. The process begins with a customer 1 contacting the web site 7 over the communications network 2. The web site home page 7 inquires whether the customer's 1 goal 3 is to pawn 4, to sell 5, or buy 6. The following three processes will occur based on which the customer selects:

Pawning 4 begins with the customer 1 selecting his goal 3 to pawn 4 a thing. The general customer 1, after selecting pawning 4, becomes a pawning customer 1.P. The web site 7 will ask questions about the thing proposed for pawning in sufficient detail so the value determination site 8 has sufficient information to make a good estimate of the thing's pawn value. The estimate is made at value determination site 8 based on the pawning customer's 1.P inputs and from information stored at the site 8. Pawn-loan site 13 information is developed from monitoring secondary markets 20 and from human estimators located at or in communication with the value determination site 8. Once a thing's pawn value estimate is made and provided to the customer 1.P, the customer 1.P can decide whether to proceed. If the customer 1.P wishes to proceed, the pawn-loan section 13 provides a pawn number to the customer 1.P and requests the thing be shipped over conventional shipping networks 17, such as the United Postal Service, to the web site's warehouse 27. The pawn-loan section 13 communicates 14 with the warehouse 27 to expect a thing inbound on the shipping network 17 and special instructions for verifying a thing's condition and the thing's disposition. Once the warehouse 27 verifies receipt of the thing and its condition, the warehouse 27 notifies the pawn-loan section 13 which, in turn, issues and maintains the pawn loan throughout the life of the loan. Once the pawn loan is paid off, the pawn-loan section 13 notifies the warehouse 27 to ship the pawned thing back to the customer 1.P.

Selling 5 begins with the customer 1 selecting as their goal 3 to sell 5 a thing. The general customer 1, after selecting selling 5, becomes a selling customer 1.S. The web site 7 will ask questions about the thing in sufficient detail so that the value determination site 8 has sufficient information to make a good estimate of the thing's resale value. The estimate is made at the value determination site 8 from information collected from monitoring secondary markets 20 or from human estimators located at or in communication with the value determination site 8. Once the thing's resale value estimate is provided to the customer 1.S, the customer 1.S must decide whether to proceed. If the customer 1.S wishes to proceed, the sell section 15 provides a selling number to the customer 1.S and requests the thing be shipped over conventional shipping networks 17, such as the United States Postal Service, to the web site's warehouse 27. The sell section 15 has a communications link 14 to the warehouse 27 to forward information on expected things inbound on the shipping network 17 and instructions concerning verifying its condition and its disposition. Once the warehouse 27 verifies receipt and condition, the warehouse 27 notifies the sell section 15 which in turn makes payment to the selling customer 1.S.

Buying 6 begins with the customer 1 selecting as their goal 3 to buy 6 buy a thing. The general customer 1, after selecting buying 6, becomes a buying customer 1.B. The web site 7 will electronically connect the customer 1.B to the direct selling point 10 of the reselling site 9. The reselling site 9 contains detailed information, video, or other electronic descriptions of things for sale. The things for sale were acquired either from selling customers 1.S or pawning customers 1.P who defaulted on their pawn loan. The normal physical location for things is in the warehouse 27. Pawn things are under the management of the pawn-loan site 13 until the customer 1.P defaults on the pawn loan. If the pawning customer 1.P defaults on the loan, responsibility for the thing is then turned over to the reselling site 9. The reselling site 9 directs the warehouse to prepare a marketing packet on the thing. Similarly, things sold 5 by customers 1.S are under the management of the sell site 15 until the thing is received at the warehouse 26 and its condition has been verified. The responsibility for the thing is then turned over to the reselling site 9. The reselling site 9 directs the warehouse to prepare a marketing packet on the thing. This marketing packet may contain detailed information, video, and other electronic descriptions of the thing. The marketing packet is then given to the resale site 9 to be advertised on the Internet and in publications. The buying customer 1.B electronically examines and shops for things for sale at the reselling site 9. If the customer 1.B wants to buy a thing, the reselling site communicates 2 with the customer 1.B for payment. Once payment is received, the reselling site 9 communicates 26 with the warehouse 27 to ship the thing to the buying customer 1.B.

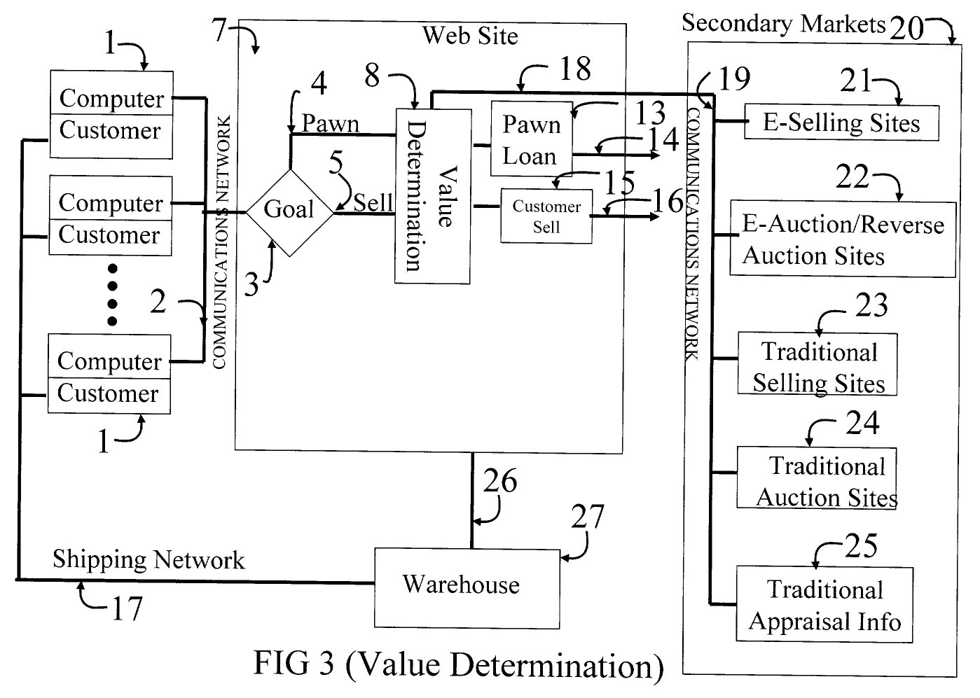

FIG. 3 depicts more details about the functions of the value determination site 8. The value determination site 8 comprises appraisers who can quickly provide an estimate of a thing over a communications network 2 with customers 1 and a communications network 19 with secondary markets 20 to monitor recent sales information. The price provided to the customers 1 contains reduction adjustments based on business expenses and desired profit margins.

The value determination process begins with a pawning or selling customer 1 communicating with the web site 7 stating their goal 3 that they have a thing to sell 5 or pawn 4. Value determination site 8 will provide the customer 1 an electronic screen form to fill in the blanks describing the thing for sale. The value determination site 8 may ask additional information, if required. The value determination site 8 builds a classification of the thing, such as manufacturer, model, age, condition, color, etc. The value determination site 8 then compares the recent selling prices of similar things in secondary markets and estimates the sales price for the thing in secondary markets 20. The value determination site 8 then calculates business factors in terms of required costs to resell the thing. These costs include the general administration cost for operating the website; inspection costs; storage costs; and shipping costs. Profit margin is also built into the cost model. Once these factors have been computed, the secondary market resale price estimate is reduced and the pawning or selling customer 1 is provided with a pawn price or price that the web site 7 will buy the thing. After the thing is bought from a customer 1 and resold directly by the web site 7 the resold price is examined. Appraisers determine how close the estimate was to the reselling price, then the value determination site updates its database.

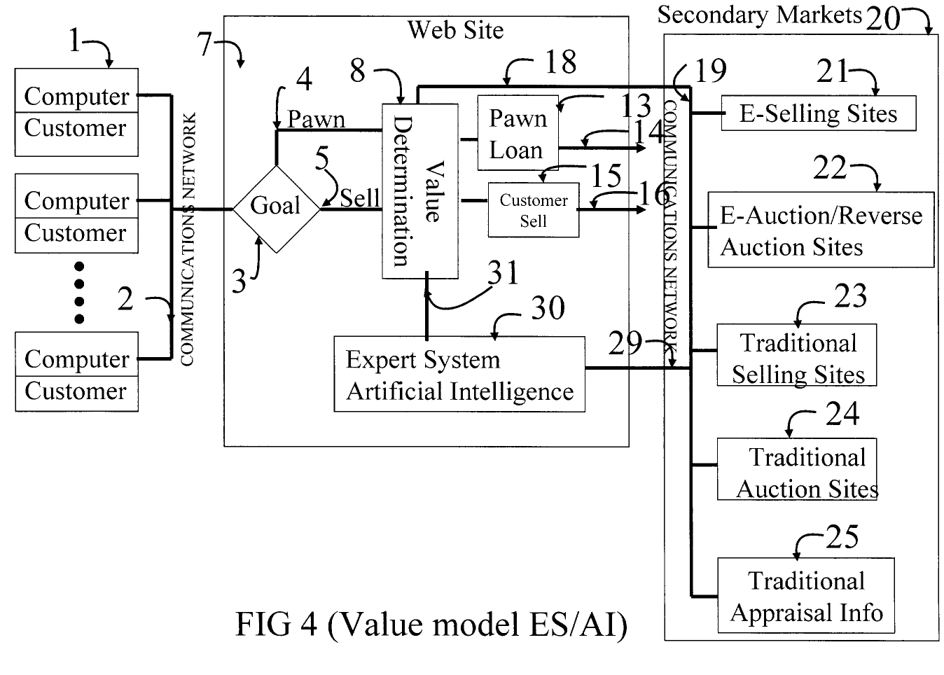

FIG. 4 depicts an alternate embodiment of the value determination site 8 with the addition of an expert system using artificial intelligence system (ES/AI) 30. The ES/AI 30 comprises hardware and software that, through a communications network 29 with secondary markets, 20 monitors and receives inputs on daily transactions. The ES/AI 30 collects information on transactions and builds a database that automatically organizes and categorizes information based on such factors as: manufacturer; model; age; condition; color; where and when things were sold; sellers; and buyers, etc. With this data, and using a basic expert system and/or artificial intelligence algorithms, the value of similar things can be extrapolated. This extrapolated value is provided through a link 31 to, or collocated with, the value determination site 8. The value determination site 8 then applies standard business cost adjustments discussed above to reduce the pawning or selling price to the customer 1. It is envisioned that with an ES/AI 30 system, buying and pawning price estimates can be provided directly to customers 1 from the web site 7 without requiring human intervention in the process at the web site 7. This could lead to a very efficient process whereby a significant number of customers ask about the estimated value of many things over a broad spectrum. This would be similar to a “Blue Book” price for a large spectrum of things and the price is backed by an instant option to sell for that price.

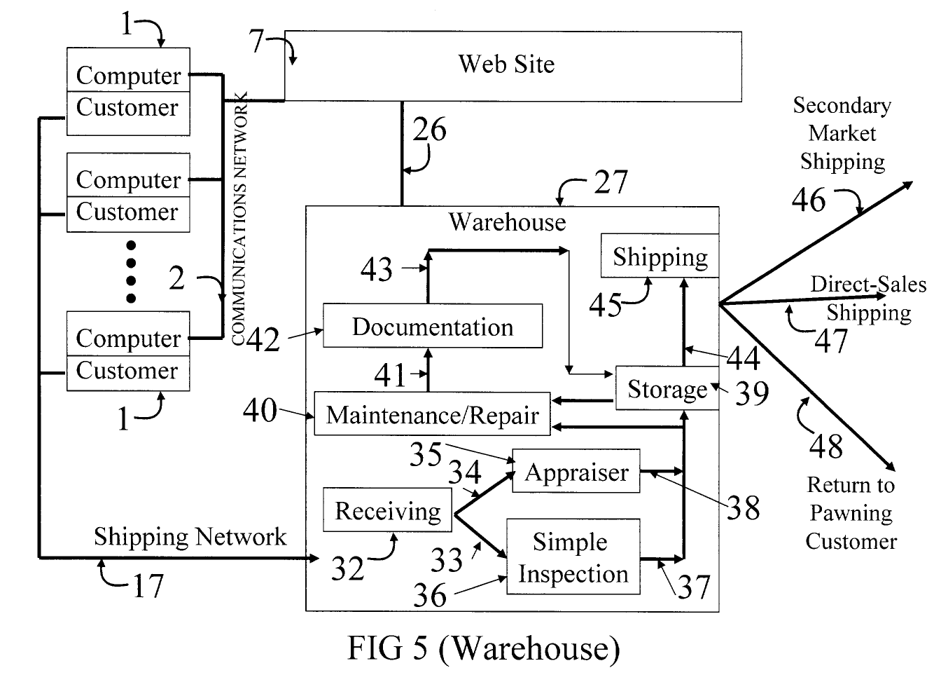

FIG. 5 depicts more detailed operation of the warehouse site 27. The warehouse site 27 process begins with a message from the pawning or selling website 7 that a thing is being shipped 27 to the warehouse. The message includes a tracking number that is used to reference the customer provided thing description and the price estimate generated by the web site 7, along with any special instructions. Once the thing arrives in the receiving section 32 the receiver looks in the special instructions section of the web site 7 message to see if the thing requires a simple inspection 36 or a specialized appraiser 35. Things that are sent 33 for simple inspection 36 are normally low-dollar things whose condition can be easily verified from initial description and price estimate sheets. Simple inspections do not require a specialized examiner. Specialized appraisals 35 are normally conducted on high-dollar things, complex things, or things for which a simple inspection is not sufficient. Appraisers 35 are normally specialized and reconfirm the thing's condition and price estimate. Once an thing's condition has been confirmed through simple inspection 36 or detailed appraisal 35 at the warehouse 27, appropriate management offices within the web site 7 organization, are informed and the thing is forwarded to storage 39 to be held or maintained/repaired 40. The pawning or selling customer 1 is informed of the final price and the customer 1 has the option to accept the value or request that the thing be shipped back. When inspectors 36 and appraisers 35 find that things do not match the customer's description documentation or the web site's value model they send their inspection results to web site 7 managing officer. The management offices then inform the customer 1 of the adjusted valuation. The customer 1 can then decide whether to accept the new value or request that the thing be returned.

Things that are pawned and held in storage 39 remain in storage until the pawning office notifies the warehouse 27 to either forward 44 the thing to shipping 45 to be returned to the pawning customer 48 or transfer the thing to maintenance/repair 40 to be prepared for sales. Things in maintenance/repair 40 are serviced then forwarded 41 to documentation 42. In the documentation section 42 an electronic information and marketing packet is developed. This marketing information packet is sent to the reselling site 9 in the web site 7. The thing is then sent 43 from the documentation site 42 to the storage site 39 where it will remain until it is sold. Once an thing is sold, the reselling site 9 in the web site 7 will inform the storage site 39 to transfer 44 the thing to shipping 45 for forwarding to a buyer from the direct sales 47 or secondary markets 46.

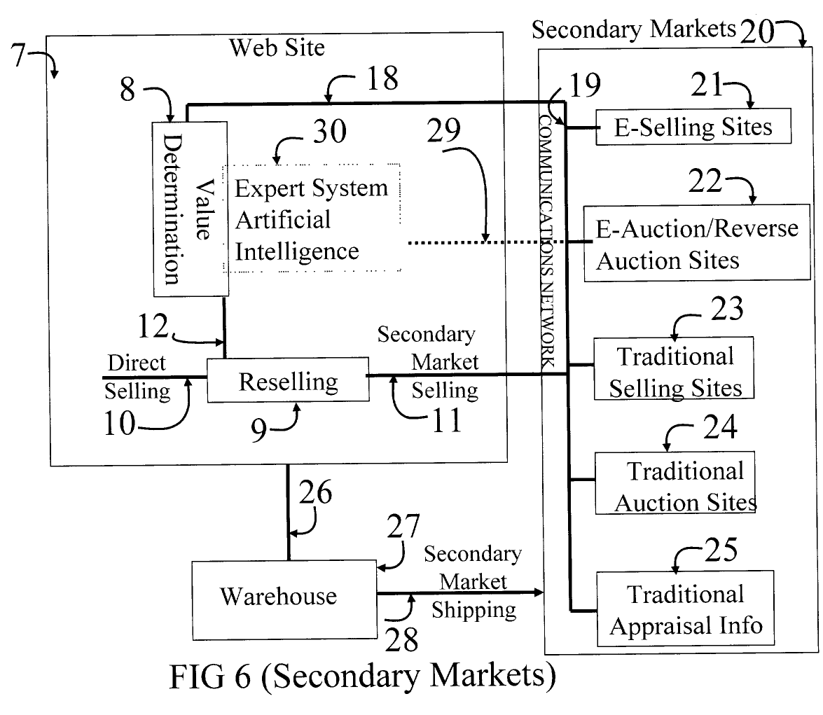

FIG. 6 depicts more details on secondary market 20 interactions and operations. Secondary markets 20 consist of electronic and traditional auction, buying, and selling sites for new and used things. Secondary markets 20 provide two valuable functions in this invention. First, secondary market transactions provide input data on current transactions over a communications network 18 into the value determination site 8 or over a communications network 29 into the expert system 30. Additionally, secondary markets 20 provide reselling outlets for things acquired through customer 1 pawn defaults and customers 1 direct selling to the web site 7. The web site reselling section 9 looks to various secondary markets 20 and determines the best location to sell a particular thing. Early in the process, the value determination site 8 documents a thing's detailed description and selling price, along with the secondary market and location. The reselling site 9 would use this data to attempt to sell 11 in the secondary market 20. The secondary market comprises Internet selling and buying sites 21, Internet auction and reverse auction sites 22, traditional selling sites, such as newspapers or used equipment catalogs, or traditional pawnshops 25. Traditional value determination books, appraisal guidelines, and cost estimating databases are also used. More weight is given to recent sales prices rather than what a thing “should cost”. When a buyer is found in the secondary market 20, and payment is made, the reselling site 9 sends instructions out over a communications link 26 to the warehouse 27 to ship the thing 28 to the buyer.

### DESCRIPTION AND OPERATION-ALTERNATIVE EMBODIMENTS

An alternate embodiment for the system and method of electronic value determination and pawn brokering is the addition of an expert system using artificial intelligence system (ES/AI) FIG. 4 Item 30. The ES/AI 30 comprises hardware and software that, though a communication network 29 with secondary markets 20, monitors and receives inputs on daily transactions. The ES/AI 30 collects information on transactions and builds a database that automatically organizes and categorizes information on a thing such as its manufacturer, model, age, condition, color, where and when the thing was sold, sellers, and buyers, etc. Entering this data into a rule-based expert system with artificial intelligence algorithms, the value of similar things can be extrapolated. This extrapolated value is provided through a link 31 to, or collocated with, the value determination site 8. The value determination site 8 then applies business cost adjustments discussed above to reduce the pawning value price to the customer 1. It is envisioned that with an ES/AI 30 system, buying and pawning price estimates could be provided directly to customers 1 from the web site 7 without requiring human intervention at the web site 7 to become involved in the process. This could lead to a very efficient process whereby a significant number of customers ask the estimated value of many things over a broad spectrum. This would be similar to a “Blue Book” price for a large spectrum of things, and the price is backed by an instant option to sell for that price.

Another embodiment is combining the pawning process with today's buying, selling, auctioning, and reverse-auctioning sites. This could be envisioned as adding pawning options and valuation models to auction sites similar to “E-bay”. Customers could then pawn their thing for a loan or have the site manager buy the thing and resell it in the auction market.

Another embodiment is to use the electronic valuation determination component to provide an auctioning customer with a historical based estimate on the thing the customer wishes to sell or buy. Again, the electronic valuation determination component could function as a “Blue Book” to assist on-line buying, selling, auctioning, and reverse auctioning commerce.

Another embodiment is the addition of a simple-to-use credit card. This credit card is very unique since it requires no monthly payments and once the card is “maxed-out” the holder is not required to pay it off. The holder can walk away from the card, forfeiting his collateralized thing. The credit card can be issued to charge against the value of the thing. Options for not making monthly payments can be made and the monthly payments can be charged directly to the collateralized thing's value. Statements can show the appraised price for the pawned thing, how much money was borrowed against the pawned thing, how much was charged on the credit card, storage charges, interest charges, and how much is left. The minimum payment on every monthly statement is zero. Once the credit card is “maxed-out” the user has the option to make a payment or forfeit the collateralized thing to the broker. An example of such a transaction would be an individual who has a baseball card collection he has outgrown or needs cash for something else. He goes through the electronic pawning process described in this invention and is given a $3,000 loan credit. He elects to take $500 now and have $2,500 credit on a collateralized credit card. In the first month he charges $250 on his credit card. At the end of the first month he receives a statement that he has used $500 (initial loan) plus $250 in purchased; plus $20 interest; plus $10 holding/storage fee. He therefore has 2,220 credit of which he can pay anywhere from $780 to $0. Interest rates accumulate, storage charges accumulate but there are no late charges, penalties, defaults, bankruptcies, or bad credit implications. Persons with bad credit are also not turned away from this process not denied a credit card.

A pawned thing can also provide credit to existing non-collateralized credit cards. The customer can elect to receive the thing's credit value transferred to on of his existing credit cards to pay down a balance to create a positive balance.

What I claim as my invention is:

1. An electronic transaction system, comprising:
(a) a host computer network, the host computer network including a database server that electronically stores and organizes things by at least one of descriptions, appraisals, sales history and geographic region, in response to inputs from electronic data and manual inputs;
(b) at least one computer workstation at at least one location the computer workstation including means to send user commands to the host computer network, and means to allow a user to ascertain at least one of values, sales information and loan instructions of selected one of the things retrieved and transmitted from the host computer network;
(c) a communications network system electronically linking the at least one computer workstation to the host computer network;
(d) a set of user application modules which cause the at least one computer workstation and host computer network to generate at the means a series of command options selectable by the user to generate the user commands, whereby the selected portions of the data stored on the host computer network are located, organized, and transmitted over the communications network system to the at least one workstation in response to one or more particular user commands and are ascertained at the means;
(e) an electronic data description of a thing to be transacted, whereby said host computer generates and transmits forms and questions concerning the thing's description over the communications network system, after which the user electronically enters the thing's description and transmits said description via the communications network system; and
(f) an appraising system for estimating the thing's value based on said electronic data description.

2. The system of claim 1, further comprising:
(a) a warehouse system;
(b) a transportation system receiving things and linking users to said warehouse system; and
(c) an inspection and appraisal confirmation system located in said warehouse system for examining things received over said transportation system.

3. The system of claim 1, wherein said the communications network system is configured to electronically link a plurality of secondary buying and selling markets with the host computer network.

4. The system of claim 1, further comprising valuation algorithms to consider secondary market buying and selling data, and to extrapolate a similar thing's estimated value if sold in a secondary market.

5. The system of claim 1, further comprising algorithms to consider the thing's estimated value and subtract from said thing's estimated value percentages to offset at least one of costs, and risks, and to provide a profit margin thereby establishing an offering price.

6. The system of claim 1, where in elements (a) through (f) are used with at least one of electronic auctioning, reverse-auctioning, buying and selling sites.

7. In an electronic value determination expert system for estimating a selling price of a thing to be sold on an open market based on said thing's description with a database of recently sold similar things having the capability of determining an offering price of said thing based on reductions from the selling price estimate that said thing can be resold for on the open market, the system comprising:
(a) a networked computer containing rules, logic functions and algorithms that automatically extrapolate an thing's value and resale price adjustments;
(b) a plurality of secondary buying and selling markets for similar things;
(c) a communications network electronically linking said plurality of secondary buying and selling markets with said networked computer; and
(d) a historical database of things' descriptions and selling prices which are automatically collected by and reside in said networked computer.

8. In the system of claim 7, further comprising a communications network system with one or more Internet users allowing any such Internet user to have a connection with said expert system for fully automated things value estimates or resale price adjustments.

9. A method of using an electronic valuation determination system for estimating a selling price of a thing to be sold on an open market based on said thing's description with a database of recently sold similar things having the capability of determining an offering price of said thing based on reductions from the selling price estimate that said thing can be resold for on the open market, the system comprising: a networked computer containing rules, logic functions and algorithms that automatically extrapolate a thing's value and resale price adjustments; a plurality of secondary buying and selling markets for similar things; a communications network electronically linking said plurality of secondary buying and selling markets with said networked computer; and a historical database of things' descriptions and selling prices which are automatically collected by and reside in said networked computer for one or more electronic auctioning, reverse-auctioning, buying and selling.

10. A system for providing pawn brokerage services among pawning, selling, and buying customers over an on-line computer network, comprising:
(a) means for estimating a resale price of a thing at which a pawn broker expects to sell said thing;
(b) means for estimating a pawn price that the pawn broker should offer the pawing customer for said thing;
(c) means for transmitting forms to and receiving detailed things descriptions from said pawning customer;
(d) means for transmitting to said pawning customer estimated pawn price along with individually generated pawn number to accompany said thing when shipped to the pawn broker; and
(e) means for receiving said thing at a holding facility and for confirming said thing's condition with the original data provided by the pawning customer and data used in providing the estimated pawn price.

11. The system of claim 10, further comprising means for storing said thing in a warehouse if said thing is to be used for a pawn loan.

12. The system of claim 10, further comprising means for photographing, writing a detailed text description, and conducting minor maintenance if required.

13. The system of claim 10, further comprising means to sell said thing directly to a customer, broker, or secondary market.

14. The system of claim 10, further comprising means for providing funds for loaning or buying said thing from the pawning customer or the seller.

15. The system of claim 10, further comprising means for monitoring said loan to completion and then returning said thing to the pawning customer.

16. The system of claim 10, further comprising means for marketing said thing if the pawning customer defaults on loan or if said thing was requested to be sold by said pawning customer.

17. The system of claim 10, further comprising means for transmitting data of successfully sold things to an expert valuation appraisal system to update refining appraisal accuracy;

18. The system of claim 10, further comprising means for virtual modeling to assist in marketing the thing over an Internet system.

19. The system of claim 10, further comprising means for determining the resale price of the thing on the open market having:
(a) means for collecting a maximum amount of data on recent and things sold, auctioned, appraised or exchanged on available electronic and traditional markets;
(b) means for updating said detailed data;
(c) means for collecting geographical locations, transportation costs and special considerations information for each market; and
(d) means for applying an expert valuation system using rules and algorithms to said commerce data and computing the pawned thing's most likely resale price that the pawn broker should receive and in which market he should sell.

20. A method for determining pawn price responsive to an expert system, comprising:
(a) first means for categorizing a thing to be pawned and obtaining specific descriptive factors including at least one of age, model, make, usage, damage and color;
(b) second means for collecting geographical locations, conditions, and special information on the thing to be pawned;
(c) third means for entering the pawn broker's business factor into an expert valuation system that will automatically take the price the pawn broker can expect to sell the thing for on the open market and subtract said business factors to determine the pawn price that the pawn broker will offer the pawning customer as loan or purchase value of the thing;
(d) forth means for using an electronic transaction system, comprising a host computer network, including a database server that electronically stores and organizes things by at least one of descriptions, appraisals, sales history and geographic region, in response to inputs from electronic data and manual inputs;
(e) at least one computer workstation at at least one location, including means to send user commands to the host computer network, and fifth means for allowing a user to ascertain at least one of values, sales information and loan instructions of selected one of the things retrieved and transmitted from the host computer network;
(f) a communications network system electronically linking the at least one computer workstation to the host computer network;
(g) a set of user application modules which cause the at least one computer workstation and host computer network to generate at the fifth means a series of command options selectable by the user to generate the user commands, whereby the selected portions of the data stored on the host computer network are located, organized, and transmitted over the communications network system to the at least one workstation in response to one or more particular user commands and are ascertained at the fifth means;
(h) an electronic data description of a thing to be transacted, whereby said host computer generates and transmits forms and questions concerning the thing's description over said communications network system, after which the user electronically enters the thing's description and transmits said description via said communications network system; and
(i) an appraising system for estimating the thing's value based on said electronic data description;
comprising the step of using said system in on-line brokering pawn brokering.

21. A method for determining the pawn price responsive to an expert system comprising:
(a) first means for categorizing a thing to be pawned and obtaining specific descriptive factors including at least one of age, model, make, usage, damage and color;
(b) second means for collecting geographical locations, conditions, and special information on the thing to be pawned;
(c) third means for entering the pawn broker's business factor into an expert valuation system that will automatically take the price the pawn broker can expect to sell the thing for on the open market and subtract said business factors to determine the pawn price that the pawn broker will offer the pawning customer as loan or purchase value of the thing;
(d) forth means for using an electronic transaction system comprising a host computer network, the host computer network including a database server that electronically stores and organizes things by at least one of descriptions, appraisals, sales history and geographic region, in response to inputs from electronic data and manual inputs;
(e) a least one computer workstation at at least one location the computer workstation including means to send user commands to the host computer network, and fifth means for allowing a user to ascertain at least one of values, sales information and loan instructions of selected one of the things retrieved and transmitted from the host computer network;
(f) a communications network system electronically linking the at least one computer workstation to the host computer network;
(g) a set of user application modules which cause the at least one computer workstation and host computer network to generate at the fifth means a series of command options selectable by the user to generate the user commands, whereby the selected portions of the data stored on the host computer network are located, organized, and transmitted over the communications network system to at least one workstation in response to one or more particular user commands and are ascertained at the fifth means;
(h) an electronic data description of an thing to be transacted, whereby said host computer generates and transmits forms and questions concerning the thing's description over said communications network system, after which the user electronically enters the thing's description and transmits said description via said communications network system; and
(i) an appraising system for estimating the thing's value based on said electronic data description;
comprising the step of using said system in on-line financial lending.

22. A electronic transaction financial credit system comprising:
(a) a thing used for collateral;
(b) a physical holding location for said thing;
(c) a transportation system to ship said thing to the physical holding location;
(d) an appraisal system to determine the credit value of said thing; and,
(e) a credit lending system to lend money to the user for said thing.

23. The financial credit system of claim 22, further comprising a credit card as the credit lending system.

24. The financial credit systems of claim 22, further comprising electronic credit transaction system into common credit card accounts.

25. A method of using an electronic database financial credit system for lending money against a collateralized thing, comprising:
(a) estimating the value of the thing;
(b) transporting said thing to a physical holding location;
(c) appraising said thing to determine its credit value; and,
(d) lending money for said thing, whereas steps (a)-(d) are carried out with an electronic database and communication network.
